(19) United States
(12) Patent Application Publication
(10) Pub. No.: US 2007/0033129 A1
(43) Pub. Date: Feb. 8, 2007

(54) Automated system and method for monitoring, alerting and confirming resolution of critical business and regulatory metrics

(76) Inventor: Frank J. Coates, West Chester, PA (US)

Correspondence Address: JOHN W. GOLDSCHMIDT, JR. ESQUIRE;DILWORTH PAXON LLP, 3200 MELLON BANK CENTER, 1735 MARKET STREET, PHILADELPHIA, PA, 19103, US

(21) Appl. No.: 11/498,497

(22) Filed: Aug. 2, 2006

Related U.S. Application Data
(60) Provisional application No. 60/705,218, filed on Aug. 2, 2005.

(51) Int. Cl. G06Q 40/00

(52) U.S. Cl. 705/36 R

(57) ABSTRACT

A system and method for monitoring specified metrics is disclosed. The system and method comprises a data collection engine which collects data related to said metrics, a data analysis engine which analyzes the data collected by the data collection engine to produce analyzed data related to the specified metrics, a data storage repository which provides a repository for the data collected by the data collection engine, and the analyzed data produced by the data analysis engine, and a dashboard monitoring system may provide both input and output functionality. As an input device, the dashboard monitoring system may enable a user to directly input data into the system without involving third parties or utilizing the data collection, data analysis, or data storage modules of the system. As an output device, the dashboard monitoring system may provide a mechanism for reporting the data collected by the data collection engine, and the analyzed data produced by the data analysis engine. In one embodiment, the system and method of the invention automatically or semi-automatically collects, monitors, analyzes, and reports specified metrics related to one or more financial investment funds or other investment vehicle. The dashboard monitoring system and method of the invention may comprise an interactive graphical user interface which may display specified collected and/or analyzed data corresponding to the metrics related to a financial investment vehicle being monitored. Authorized users of the system may alter parameters related to the monitored metrics to modify comparative thresholds and/or to generate theoretical situations or “What if?” scenarios to forecast or otherwise anticipate fund performance based upon such alterations to metric parameters. The system and method of the invention may be used by fund boards of directors, fund advisors, fund management, as well as institutional and other investors to assist in decision making processes. An automated alert system may also be provided to alert select system users if specified fund metrics fall outside of established fund thresholds.

### CROSS REFERENCE TO RELATED APPLICATION

This application claims the benefit of United States Provisional Patent Application Serial No. 60/705,218, entitled “Automated System and Method for Monitoring, Alerting and Confirming Resolution of Critical Business and Regulatory Metrics” filed Aug. 2, 2005, which is incorporated herein by reference in its entirety.

### FIELD OF THE INVENTION

This invention relates generally to enhancing decision making processes and, more specifically, to automated systems and methods for the acquisition, assimilation, analysis and reporting of information in accordance with particular parameters.

### BACKGROUND OF THE INVENTION

As the information age matures, persons, and particularly decision makers with fiduciary responsibility, are presumed to have access to, review, comprehend, and rapidly act upon vast amounts of information available from numerous sources. This presumption leads to heightened expectations by others that those in a decision making and/or fiduciary capacity, such as for example members of boards of directors, chief executives and other officials, have access to and have considered such information when making decisions, setting policies or taking other action. This presumption is particularly common in the financial and investment industries. Thus, the need exists for a system and method which enables and enhances the ability of an individual or set of individuals, and particularly those in a decision-making and/or fiduciary capacity, to monitor, assimilate, comprehend, and evaluate certain information, to compare such information to established business, industry and/or government regulated metrics or criteria, and to provide such individuals with a concise, easily comprehended summary of such comparison in order to assist such individuals in reacting to such information in a rapid, efficient and fiduciary manner.

### SUMMARY OF THE INVENTION

The present invention relates to a system and method for monitoring, assimilating, collecting, and reporting a set of customizable metrics based upon the collection of relevant data that may be available internally or acquired from sources external to an individual or organization collecting such data. This data is compared to predetermined thresholds through a set of established algorithms, protocols and/or rules.

The results of this comparison may then be reported through a customizable output mechanism, such as an interface “dashboard,” which may be easily read and comprehended by a user of the system of this invention. The reported output information may thus be used by individuals to react to and/or otherwise make decisions based upon such information. In addition, the dashboard interface may permit the metric, dashboard, processing, threshold and/or other settings to be adjusted in accordance with desired parameters.

The system and method of the present invention enables users to more easily meet their responsibilities including, but not limited to, their fiduciary and other official duties. In the case where the users comprise an Investment Fund Board of Directors, the system and method of this invention may comprise one or more of the following features including: (i) establishing decision making guidelines for managing a portfolio of funds on behalf of shareholders; (ii) providing Directors with an independent source of advice and information; (iii) providing the Fund Board of Directors with a record of Board activities on behalf of shareholders; (iv) reduction in the potential for conflict of interest when delivering information and data to the Board; (v) reduction in the number of staff needed to gather and analyze information; (vi) simplified compliance with established Fund objectives through the availability of current data when actual fund performance is not meeting fund objectives; and/or (vii) enhanced control of Fund expenses.

By way of non-limiting example, the system and method of one embodiment of this invention may operate as follows:
1. Set system parameters including, but not limited to, policies, guidelines and thresholds. The board, fund manager, and other advisors work with system administrative staff to develop and maintain policies and guidelines for each fund. Action steps for “out of compliance” events may be set in advance.
2. Analyze data for metrics and other parameters which fall outside the predetermined threshold values. System administrative staff, as well as the system itself, may analyze find related data to determine variances with thresholds set by the board, fund manager or other authority.
3. Monitor established fund indicators. The board, fund manager, or other user monitors fund performance and other indicators through an output interface such as, for example, the Mutual Fund Dashboard. See FIG. 4 for an example of a dashboard output interface for a fictitious fund named “iConceptsfund.” Based upon this output data, a user may then request specific data from system administrative personnel or retrive such information through the system itself.
4. Take corrective action as warranted. System administrative personnel and/or the system itself may initiate action prescribed in advance such as issuing an alert to board, find manager or other users through the dashboard output interface. Alerts may include, for example, (i) automatically generating an e-mail which is sent to the board, fund manager or other user, or (ii) through colored indicators displayed on the dashboard (such as for example red, yellow and green lights indicating whether the measured parameter is outside the established threshold (red), the parameter is near but has not exceeded the threshold (yellow), or the parameter is within the established threshold (green).

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, in which like numerals refer to like parts, and wherein:

FIG. 1 depicts a flow diagram illustrating an embodiment of the metrics monitoring system of the present invention;

FIG. 2 depicts a flow diagram illustrating another embodiment of the metrics monitoring system of the present invention;

FIG. 3 depicts one embodiment of the architecture and dataflow diagram of the metrics monitoring system of the present invention;

FIG. 4 depicts an embodiment of the dashboard output interface of the present invention;

FIGS. 5A and 5B depict an aspect of the present invention in which parameters, thresholds, metrics and other business rules are developed and incorporated into the system and method of the present invention; and

FIGS. 6A and 6B depicts relational database and connections diagram of one embodiment of the system and method of the present invention.

FIG. 7 is a schematic depicting the interaction by various Users with the System of this invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in a typical inventory tracking system. Those of ordinary skill in the pertinent art will recognize that other elements are desirable and/or required in order to implement the present invention. However, because such elements are well known in the art, and because the do not facilitate a better understanding of the present invention, a discussion of such elements is not provided herein.

Reference will now be made in detail to several preferred embodiments of the present invention, examples of which are illustrated in the accompanying drawings.

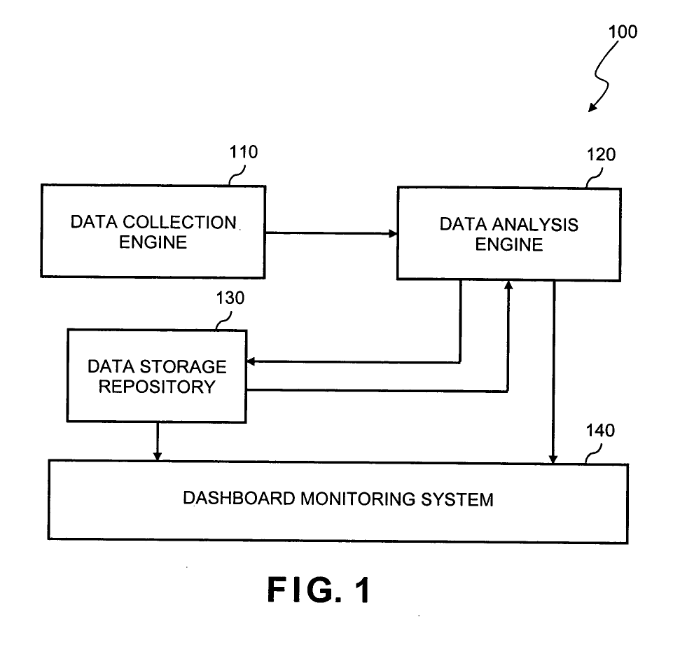

Turning now to FIG. 1, there is shown a flow diagram illustrating an embodiment of the Metrics Monitoring System 100 of the present invention. In this embodiment, System 100 comprises Data Collection Engine 110, which mines relevant data, and which data may be available from any public or non-public source. Data Collection Engine 110 may acquire such data by manual or automated systems. Generally, the data collected by Data Collection Engine 110 is data relevant to the Metrics being monitored.

System 100 further comprises Data Analysis Engine 120 which contains a set of predetermined algorithms, parameters, protocols and/or rules which are relevant to the Metrics being monitored. Such algorithms, parameters, protocols and/or rules may be established by Authorized Users of System 100 and modified by Authorized Administrators of System 100. Data collected by Data Collection Engine 110 may then be analyzed relative to the predetermined algorithms, parameters, protocols and/or rules by Data Analysis Engine 120. Data analysis engine 120 may analyze data against any set of algorithms, protocols, rules or other parameters so as to provide users with virtually any output metrics desired. For example, analysis of data may be made relative to historical past performance, established metrics, or any other parameter desired.

Data collected by Data Collection Engine 110, historical data based upon data previously analyzed by Data Analysis Engine 120 or other source, and/or data currently analyzed by Data Analysis Engine 120 may be stored in Data Storage Repository 130. Data stored in Data Storage Repository 130 may be secured from modification or other changes so as to maintain a reliable source of historical and other data.

System 100 of FIG. 1 also comprises Dashboard Monitoring System 140, which may itself comprise a “dashboard” type interface. Dashboard Monitoring System 140 may be configured to provide various functionality including acting as an input and/or output device.

As an input device, Dashboard Monitoring System 140 may enable the User to directly input data, or other information, to Dashboard Monitoring System 140, which data may change the output of Dashboard Monitoring System 140, without the need of passing such data through, or otherwise interacting with, Data Collection Engine 110, Data Analysis Engine 120, and/or Data Repository 130 (hereinafter the “Direct Data Input Function”). The Direct Data Input Function may be particularly useful and/or desirable when using highly sensitive or other non-publicly available data with System 110, inasmuch as this function does not require the User to disclose the data to a third party (such as, for example, a System Administrator), or store such data on System 100 where it may be retrieved or otherwise seen by another. While the Direct Data Input Function preferably bypasses Data Collection Engine 110, Data Analysis Engine 120, and Data Repository 130, System 100 may be configured to permit one or more of these features to be used in conjunction with the Direct Data Input Function.

As a non-limiting example, it may be desirable for a User to track, through Dashboard Monitoring System 140, the number of trades a Fund Manager is executing in a given month with respect to a particular Fund. Such information is viewed in the investment industry as highly confidential. Utilizing the Data Input Function, the User may input this data directly into Dashboard Monitoring System 140 to track the number trades while maintaining the confidentiality of the information.

As an output device, Dashboard Monitoring System 140 may be used for reporting customized output metrics based upon, for example, analyzed data generated and received from Data Analysis Engine 120. Users and/or administrators may also modify various output generated by Dashboard Monitoring System 140. For example, authorized users and/or administrators may add, delete, or modify metric, dashboard and threshold settings through Dashboard Monitoring System 140. In addition, end users of System 100 may access the output generated by Dashboard Monitoring System 140 and utilize such output for any desired purpose such as, for example, in a decision making process.

System 100 may also be configured to automatically alert end users as to the occurrence of particular events based upon the output of Dashboard Monitoring System 140. System 100 may also be configured to allow users to provide System 100 with confirmation that a reported event has been acknowledged, addressed, resolved or otherwise dealt with.

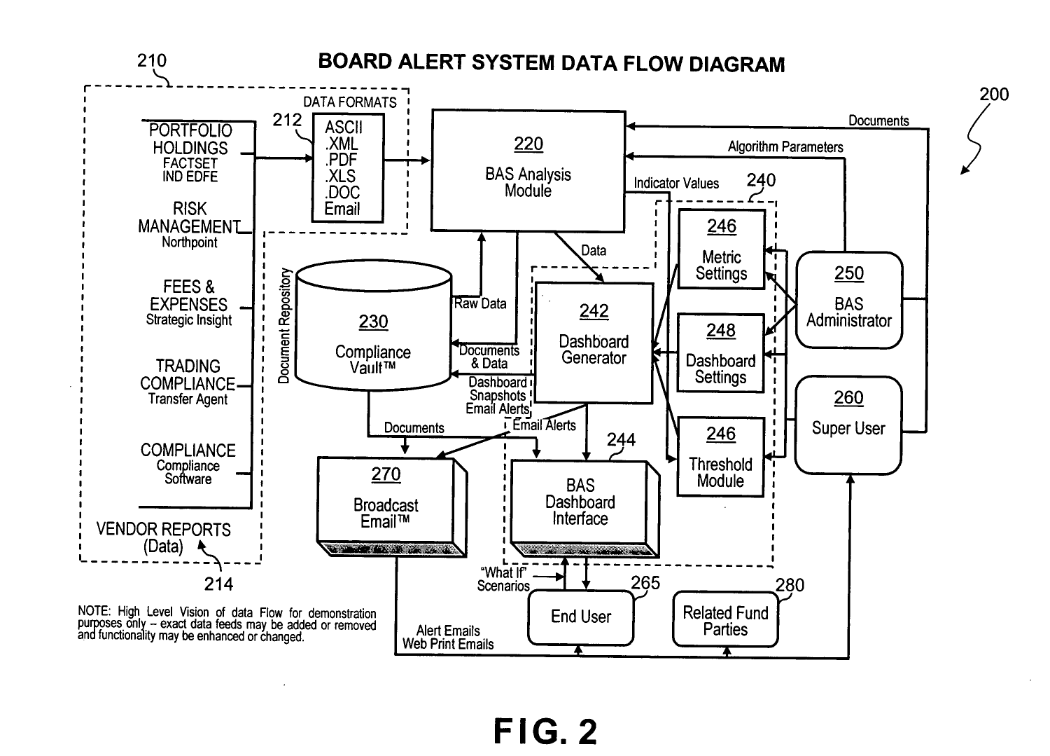

Turning now to FIG. 2, there is shown a flow diagram of metric monitoring System 200 illustrating yet another embodiment of the instant invention.

System 200 comprises Data Collection Engine 210, Data Analysis Engine 220, designated in FIG. 2 as BAS Analysis Module 220, Data Storage Repository 230, designated in FIG. 2 as Compliance Vault 230, and Dashboard Monitoring System 240, designated in FIG. 2 as Dashboard Generator 242, BAS Dashboard 244, Metric Settings Module 246, Dashboard Settings Module 248, and Threshold Module 249. Administrator 250 may adjust System 200 Metrics through Metric Settings Module 246, and the dashboard settings through Dashboard Settings Module 248.

In the embodiment of FIG. 2, data, including documents and other information bearing material, is manually or automatically provided to BAS Analysis Module 220 from Data Collection Engine 210. Data Collection Engine 210 automatically and/or manually collects documents and other data from various sources, including, but not limited to, publicly and privately available data, third party vendor sources 215, System Administrative Staff 250 (also referred to herein as “BAS Administrator 250”) and Super Users 260, who have certain administrative access to System 200 which End Users 265 do not have. Data may also be provided to the BAS Analysis Module 220 from internal System 200 sources such as from Compliance Vault 230. The data may be provided in any format, including but not limited to, Data Formats 212 ASCII, XML, .PDF, .XLS, .DOC and by e-mail.

BAS Analysis Module 220 contains a predetermined set of algorithms, parameters, protocols and/or rules which may be relevant to the metrics being monitored. Such algorithms, parameters, protocols and/or rules may be permanently set in BAS Analysis Module 220 or may be modified where BAS Administrator 250 has the authorization to change such algorithm, parameter, protocol and/or rule. Once Analysis Module 220 has analyzed the data, the data is transferred to Dashboard Generator 242. Analysis Module 220 may also provide certain indicator values to Threshold Module 249 (described in further detail below). Also, documents and other data may be transferred from Analysis Module 220 to Compliance Vault 230 for archiving and subsequent retrieval.

Compliance Vault 230 acts as a repository for documents, historical and other data deposited by Analysis Module 220 and Dashboard Generator 242. Such data stored in Compliance Vault 230 may be released by Compliance Vault 230 to Analysis Module 220, BAS Dashboard Interface 244 or Broadcast E-Mail Generator 270 (described in further detail below). Data disseminated from Compliance Vault 230 may be partially or wholly restricted from dissemination depending upon the classification of the data or other established parameters.

Data from Analysis Module 220 is received by Dashboard Generator 242. Authorized Super Users 260 may set and/or modify desired Thresholds 249, Dashboard Settings 248, and Metric Settings 246 to be used in further evaluation and reporting of the data received from Analysis Module 220. Authorized BAS Administrator 250 may also set and/or modify Metric Settings 246 and Dashboard Settings 248. Thresholds 249 may also be set by indicator values received from Analysis Module 220. Once Thresholds 249, Dashboard Settings 248 and Metric Settings 246 are established and data is received, Dashboard Generator 242 populates BAS Dashboard Interface 244 through which System 200 output is displayed in accordance with the Threshold 249, Dashboard Settings 248 and Metric Settings 246.

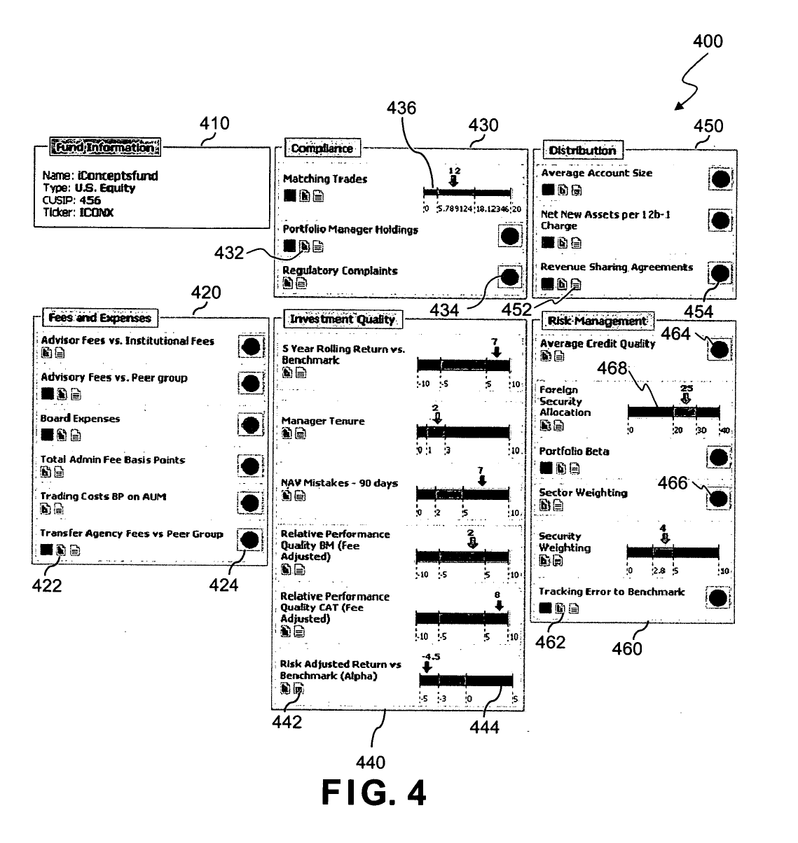

FIG. 4 sets forth exemplary graphical output, labeled 400, and referred to herein as Screen 400, which may appear on an output screen generated by, for example, Dashboard Monitoring System 140, Dashboard Interface 244, or other System interface in accordance with the instant invention. Screen 400 comprises: Fund Information Field 410 which describes the fund name, fund type, CUSIP number and Tickler; Fees and Expenses Field 420 which depicts fund fee and expense metrics tracked, and Color Metric Status Indicators 424, in which the status of a metric is depicted in a color such as red (indicating that the metric exceeds the threshold), yellow (indicating that the metric is approaching the threshold), or green (indicating that the metric is within the threshold); Compliance Field 430 which depicts compliance metrics tracked, Color Metric Status Indicators 434, and Relative Status Indicator 436, in which the status of a metric is depicted in relative form such as a bar graph indicating a metric status range; Investment Quality Field 440 which depicts investment quality metrics tracked, and Relative Status Indicators 444; Distribution Field 450 depicting account size, asset and revenue sharing distribution metrics, and Color Status Indicators 454; and Risk Management Field 460 which depicts risk management metrics tracked, and Color Status Indicators 466, and Relative Status Indicators 468. Documents and other data recovered from Compliance Vault 230 may also be disseminated through Dashboard Interface 244 as, for example, File or Document Attachment Link Icons 422, 432, 442, 452 and 462.

Authorized End Users 265, Related Fund Parties 280 (which may include, for example, authorized institutions, advisors and parties which have been granted access to some or all of System 200), and Super Users 260 may then interact with System 200 through BAS Dashboard Interface 244, wherein such interaction may include, but not limited be limited to, viewing the output of Dashboard Interface 244 based upon data produced by Analysis Module 220 and Dashboard Generator 242, and creating “What if?” scenarios. “What if?” scenarios may permit authorized users (which may comprise End Users 265, Related Fund Parties 280, and/or Super Users 260) to reset or otherwise alter select values reported through Dashboard Interface 244 by generating alternative output based upon changes to the threshold, dashboard and/or metric parameters and output data received from the Dashboard Generator.

As an non-limiting example of a “What if?” scenario, and considering Dashboard Screen 400 of FIG. 4 where there is shown an output screen of the iConceptsfund Fund (a fictitious fund which fund comprises a portfolio of debt and equity investment funds) having preset metric, dashboard and threshold settings, End User 265 considers, “How would the Fund metrics reported by Dashboard Interface react or change if the Foreign Security Allocation of the Fund were increased by five percent (5%)?” Utilizing the “What if?” feature of Dashboard Interface 244, End User 265 increases the Foreign Security Allocation of the Fund by 5%. Utilizing the reset Foreign Security Allocation value, Dashboard Interface 244 and/or Dashboard Generator 242 then recalculates the relevant metrics reported through Dashboard Interface 244 to produce recalculated output which corresponds to the recalculated metrics based upon the 5% increase. The recalculated metrics are then displayed through Dashboard Interface 244. End User 265 may then print, save or otherwise store the recalculated metrics, or continue with additional “What if?” scenarios. Alterations made through the “What if?” Scenarios feature of the invention typically do not change the authorized metric values (e.g. Metric Settings 246, Dashboard Settings 248 and Thresholds 246) of System 200 which have been approved by the Board other authority.

Another feature of Dashboard Interface 244 includes the Direct Data Input Function described in connection with the embodiment of FIG. 1. The Direct Data Input Function may be utilized with any embodiment of the instant invention.

An additional feature of System 200 may include Broadcast E-Mail Module 270 wherein alerts, such as broadcast e-mail alerts, may be transmitted to authorized End Users 265, Related Fund Parties 280, and Super Users 260 based upon predetermined threshold, dashboard, Metric, and/or other desired settings or parameters. Documents received from Compliance Vault 230, as well as from Users of System 200, may also be disseminated by Broadcast E-Mail Module 270 to authorized End Users 265, Related Fund Parties 280 and Super Users 260.

The features and functionality of Broadcast E-Mail Module 270 may be customized to suit the particular needs of a User. For example, and without limitation, such customized features or functionality of Broadcast E-Mail Module 270 may include the ability to: (1) establish the parameters or Metrics which will activate an alert; (2) enable the designation of the parties who will receive particular alerts; (3) enable the composition of the message and associated data and documentation to be sent with particular alerts; and (4) provide a data links or other data transfer functionality to enable System 200 to interface with third party software (such as, for example, a Client's work flow or project management software resident on the Client's computer system), and automatically populate such software with select data transferred from System 200 via an alert sent through Broadcast E-Mail Module 270.

Various reports also may be generated from output of and/or data stored in System 200. For example, quarterly board meeting books and records may be generated through computerized systems, such as a printing wizard, from data generated by or stored within System 200. Such data may include documents and/or data generated by Analysis Module 220 and/or stored in Compliance Vault 230.

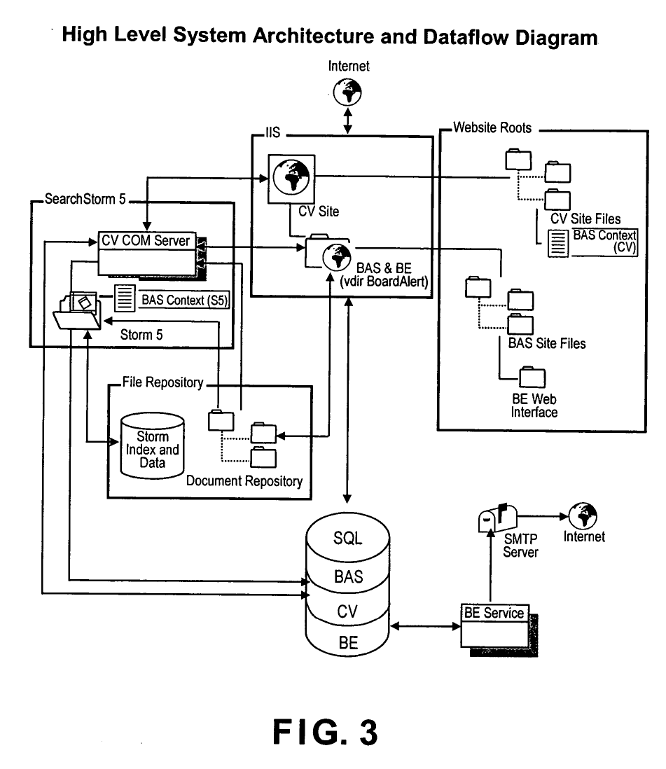

Turning now to FIG. 3, there is shown an embodiment of the System architecture and dataflow in accordance with this invention. Generally, the architecture and dataflow of FIG. 3 may be used in connection with System 200 depicted in FIG. 2, however such architecture and data paths may be adapted to other embodiments of the instant invention.

In yet another feature of the present invention, the System may be directly utilized by third party governing funds, such as, for example, individual equity, stock or other investment funds. The System may be configured, and one or more of the features of the System may be utilized, to support such governing funds. For example, the data storage and retrieval, policy making, and monitoring features described herein, may be collectively or individually utilized to provide such governing funds with the necessary functionality desired by the fund. In one embodiment, the System may comprise a web-based “dashboard,” such as the dashboard interfaces described herein, as the primary user interface which may be accessed by authorized fund users. The functionality accessible to such authorized by such authorized fund users may vary by user classification. For example, the fund manager may have the ability to view dashboard output, apply “What if?” scenarios, and alter metric and dashboard settings, while members of the fund's Board of Directors may have the ability to view dashboard output, apply “What if?” scenarios, and alter the threshold settings only. The System may also be configured to provide a fund investor, or other user, with a predetermined level of authorized access to the System. In addition to the dashboard interface, the System may be configured to provide other forms of output interfaces such as, for example, paper reports, e-mail reports and/or other distribution methods. The data used to generate such output may be stored in or retrieved from an appropriate repository. Additionally, the System may be configured to provide an administrative interface which may be utilized to provide for fund setup and user maintenance.

The System and method of the present invention may also include, without limitation, additional features which are further described under the non-limiting subheadings set forth below.

A. Subsystems

The System of the present invention may comprise a number of logical and other subsystems, such as for example the modules, engines, generators, interfaces and subsystems depicted in FIGS. 1 and 2. The functional features of the System may be generally, and without limitation, grouped into one or more of the following subsystems: 1. Fund Maintenance; 2. Administrative Access Control; 3. Dashboard Display; and 4. Repository Maintenance. Non-limiting details of such subsystems are set forth below.

1. Fund Maintenance

This subsystem generally maintains the fund parameters that are tracked and displayed on the dashboard, such as for example through Dashboard Generator 244. The purpose of this subsystem is to support the configuration of the System for each fund tracked. It should be noted that each client or user may have multiple funds tracked, each with its own parameter values or other metrics, settings and thresholds.

By way of non-limiting example, the fund maintenance subsystem of this invention may comprise the following functionality:
a. Activation and/or deactivation of fund parameters, metrics, settings and/or thresholds (collectively or individually referred to as “Metrics”) for each fund.
   i. From a display of some or all available fund Metrics, administrative or other authorized users may activate and/or deactivate the tracking of Metrics for a particular fund. Note that Metrics may be calculated for each fund, but only those that are activated may be displayed.
   ii. For each Metric value, allow administrative user to input or modify the following values. Each Metric may have default values for the following parameters:
      1. Metric Lower Limit (e.g. Lower Threshold Limit).
      2. Metric Upper Limit (e.g. Upper Threshold Limit).
      3. Metric Red/Yellow Threshold Value (e.g. Color Metric Status Indicator).
      4. Metric Yellow/Green Threshold Value (e.g. Color Metric Status Indicator).
      5. Metric Comment Text, which is printed along with the metric value on detail report.
      6. Chart Settings which specify the type of Metric data to be reflected in historical or other chart (in a bar chart, line chart, X and Y axis graph, or other graphical representation) which may display Metrics in graphical form. These charts are used to display the values of a Metric over time (for example, the last fiscal quarter) and display related Thresholds, such as, for example, the Relative Status Indicators depicted in FIG. 4. Not all Metrics may have charts available.
   iii For each Metric value, allow Administrative or other authorized user to activate, deactivate, and/or otherwise control e-mail and other alerts. An e-mail alert may be automatically generated and sent to designated addresses by, for example, Broadcast E-Mail Module 270 of FIG. 2. In one embodiment of the invention, an alert may be generated when a Metric value crosses below or above a Red/Yellow Threshold Value or above or below a Green/Yellow Threshold Value.
      1. An Administrative or other authorized user may enter an unlimited number of e-mail addresses or recipients to which particular alerts are to be sent. The Administrative user may define the parameters or rules which determine the alerts which are to be sent to particular recipients. For example, some alerts may be sent only to Fund Board Members, while other alerts may be sent to all users of the System.
      2. An Administrative or other authorized user may activate or deactivate e-mail and other alerts for Metrics which are not activated.
b. Add and/or delete funds or edit the fund name, fund ID (e.g. CUSIP and/or ticker symbol), and other fund information. See, for example, FIG. 4, and particularly Fund Information 410.
   i. Permit administrative or other authorized user to enter and/or update fund detail information, such as, for example:
      1. Description of Fund Objective;
      2. Identification of Assets Under Management (“AUM”);
      3. Identification of the Fund Record Keeper; and/or
      4. Identification of the Fund Legal Counsel.
c. Allow Administrative and/or other authorized user to upload and/or link documents to specific fund and Metric combinations. These documents may be saved to, viewed through, and/or linked to the Metric output interface display. For example, in the case of Dashboard Interface 244, documents and other data may also be disseminated through Dashboard Interface 244 as through File or Document Attachment Link Icons 422, 432, 442, 452 and 462, depicted in FIG. 4.

2. Administrative Access Control

Functionality may be incorporated into the System of this invention to provide, among other functionality, administrative access, the ability to add or delete System Users, track System usage, and high level administrative functionality. In this regard, the System may provide administrative access to users with administrative privileges through an administrative interface such as, for example BAS Administrator Interface 250, depicted in FIG. 2. The administrative access function may also block non-authorized users from seeing select administrative access displays, and permit administrators to grant administrative privileges to other users.

Among other administrative functionality, the System may include, but not be limited to the following functionality:

a. Administrative Access—The Administrative Access function of the System of this invention may include the following:
i. Permit access to the administrative interface for users with administrative privileges.
ii. May restrict administrative access for non-authorized users including, but not limited to the administrative access display.
iii. Permit Administrator to grant administrative privileges to other users.

b. Adding and/or Deleting System Users—The Administrator of the System may control User identifying information and access to the System. Set forth below are exemplary controls which the Administrator or other authorized individual may exercise with respect to System Users:
i The Administrator of the System may collect, save, edit and otherwise modify System User information for some or all Users including but not limited to the following information:
   1. Usemame;
   2. User's First Name, Last Name, Middle Name, title or name prefix, and suffix;
   3. User's E-mail address;
   4. User's Password and confirmation of User's Password;
   5. Client's or User's Firm name;
   6. Fund access control which enables the Administrator to grant the User access the funds which the User may be able to access and view through the Dashboard Interface;
   7. User title or position; and/or
   8. User type, such as whether User is independent or associated with another organization.
ii. E-mail login information for each user.
iii. Control password reset function to automatically generate new passwords and send passwords to User or client if User or client forgets password.
iv. Control System interface which may enable User to reset and/or change their password.

c. Administrator may log some or all administrative and user access data into the System, including but not limited to:
i. User session login data (e.g. userid, time, date);
ii. User Session logout data (e.g. userid, time date); and
iii. User data changed (e.g. administrative userid, time, date, data change)
d. Provide “Super User” access to search, purge, and print log information from System. System may be configured such that no other user may assign Super User access.

3. Dashboard Display and Maintenance

The Dashboard display of the Dashboard Interface of the present invention may be configured in any manner to suit a given application. FIG. 4 discloses an exemplary embodiment of the dashboard output display of the present invention. Generally, the Dashboard display may comprise one or more of the following functionality and features:
a. Generate display of Fund performance against chosen Metric parameters, including but not limited to:
   i. Administrative user access to enter, delete or otherwise modify Metric parameter values for the current and prior Metric measurement periods.
b. Create and modify the Dashboard display, including but not limited to:
   i. Display current and prior Metric measurement period indicators (e.g. traffic signal [red, yellow, green light, such as the Color Status Indicators of FIG. 4], or gauge-style graphical display [such as the Relative Status Indicators of FIG. 4], depending on metric), including ‘last updated’ date;
   ii. Display alert indicator (e.g., exclamation point) which shows that the indicator Metric has crossed a Threshold (e.g., red, yellow, or green) in the reporting period;
   iii. Capability to print a formatted version of the Dashboard display. The print version may appear different in format from screen display in order to fit on standard letter size paper; and
   iv. Provide for linking of one or more supporting documents related to the metric being reported, such as, for example, File or Document Attachment Link Icons 422, 432, 442, 452 and 462 of FIG. 4. A printing utility may be incorporated into the System to create standard packages of reports for each client.
c. Create Dashboard detail display (e.g., display supporting documents linked to a particular measurement item) including, but not limited to: (i) when user clicks on Dashboard display, present user with a display of detailed information related to the Metric (specifically, the date of the last Metric data update, the value of Metric in the current measurement period, the value of the Metric in the prior measurement period, the Yellow/Red Color Status Indicator threshold value, the Yellow/Green Color Status Indicator threshold value, the graph of values reported, the log of alert dates (i.e., when threshold values were crossed as in subparagraph b above); (ii) provide links to any supporting documents or other information which has been linked to that metric by Administrative User such as, for example, File or Document Attachment Link Icons 422, 432, 442, 452 and 462 shown in FIG. 4; and/or (iii) provide capability to print a formatted version of the detail display.
d. Archive all Metric values in a Metrics Repository, such as for example, Compliance Vault 230, for Metric comparison and reporting.
e. Provide capability for the Administrative User to modify the Dashboard display layout for each client from the Administrative Interface, including, but not limited to:
   i. Allowing the Administrative User to change the Dashboard display titles; and
   ii. Allow the Administrative User to change the Dashboard display background color (if any).
f. Allow Administrative or other authorized User to create and/or administer “My Board Alert” which allows User to have a customized display of Metric indicators and reports. This functionality may be offered as a premium feature not available to all users, which functionality may include, but not be limited to, allowing an authorized User to:
   i. Select from the Metric displays available for the client and/or Fund for inclusion in the User's personal Dashboard;
   ii. Select from available reports for the client and/or Fund for inclusion in the User's personal Dashboard; and
   iii. Select their personal dashboard as the User's default page when the User logs into the System.

4. Repository Maintenance

Data management functions, such as the storage and retrieval of documents and other data, provided for by the System may be allocated to a Repository module of the System such as, for example, Data Storage Repository 140 of FIG. 1, and Compliance Vault 230 of FIG. 2.

Additional Repository functionality may be necessary or desirable to support the Dashboard display. Specifically, the Data and Document Repository containing Fund performance against the established Metrics may be provided. The Repository may be maintained by System administrative staff or other authorized personnel, and may be updated with the results of the Administrator's analysis of incoming documentation and automated processing of incoming data feeds, such as, for example, the Vendor Data Reports 214 of FIG. 2. The support and analysis Administrative staff are preferably able to associate through the Dashboard Monitoring System (such as, for example, Dashboard Monitoring System 140 of FIG. 1, or Dashboard Generator 242 of FIG. 2) documents and data stored in the Document Repository with Metric values stored in a Metrics Repository, which Metrics Repository may comprise, for example Data Analysis Engine 120 of FIG. 1, and BAS Analysis Module 220 of FIG. 2. This functionality permits detailed documentation and data to be associated with a particular Dashboard display element, which Dashboard Display Element may comprise, for example, File or Document Attachment Link Icons 422, 432, 442, 452 and 462 of FIG. 4.

Generally, the Repository may comprise one or more of the following functions and/or features:

a. Input Data Processing
i. Importation or other updating of data maintained in the Repository may be provided on a daily (or other established period) scheduled basis of predefined data feeds from third party data providers. These data feeds may contain data values needed to calculate Metric values. Such importation and/or updating may be accomplished through, for example, Data Collection Engine 110 of FIG. 1, or Data Collection Engine 210 of FIG. 2. For performance based Metrics tracked by the System, data may be updated monthly, but may be updated either more or less frequently.
ii. Specific processing algorithms and data formats of the incoming data feeds may be provided.

b. Formatted Data Input File Processing
i. Allow for the importation, updating, and scheduled processing of predefined spreadsheet formats that contain data values needed to calculate Metric values.
ii. Specific processing algorithms and data formats may be provided through, for example, Data Collection Engine 110 of FIG. 1, or Data Collection Engine 210 (and particularly Data Formats 212) of FIG. 2.

c. Metric Generation
i. Allow for the scheduled processing of predefined Metric calculations for some or all Metrics defined in the System. Specific processing algorithms and data formats may be provided through, for example, Data Collection Engine 110 of FIG. 1, or Data Collection Engine 210 (and particularly Data Formats 212) of FIG. 2.

d. Repository Batch Reporting
i. Allow Administrative or other authorized User to define a set of reports (optionally selected from a standard list of reports) that may be generated for a client or other User.
ii. Allow Administrative or other authorized User to request creation and/or printing of a batch report for a client or other User.

e. Repository Submission
i. Allow User who is logged in to the System to create a message containing documents or other data to be sent to an Administrator or other authorized User.
   1. Allow User to attach up to at least three (3) documents or other data forms which may be forwarded to the Administrator, or other authorized User, together with message text.
ii. Provide an Administrative Interface which enables the Administrator or other authorized User to view, reply, save and/or delete the messages received from Users.
   1. All messages and attached documents and data which are saved may be stored in the Repository.
   2. Allow Administrative or other authorized User to link the message and/or attached documents and data to specific Client and/or Fund Metric(s). The User may then be able to view such information including, but not limited to, the message and attachments from a Metric detail or other display.

f. Repository Data Quality Reports Administrative and other authorized Users may be able to generate and/or retrieve data quality reports based upon data and other information contained in the Repository.

B. Other Features of Subsystems
1. Dashboard displays and/or reports may be generated on a daily (or other periodic) basis. Some data maintained by the System may not change on a daily (or other established periodic) basis. For example, data may be produced and/or otherwise updated on a fiscal quarterly schedule (i.e., each quarter ending on March 31, June 30, September 30, and December 31, respectively), preferably corresponding to the most current financial and other relevant data available for a fund.
2. Once a dashboard display and/or report is generated, such display or report may be archived.
3. The System may be configured to be deployed at Client or other User sites, such as, for example, at fund companies. The System may also be locally or remotely hosted or accessed through the World Wide Web, Internet or an extranet.
4. The System may use “Compliance Vault,” such as Compliance Vault 230 of FIG. 2, as the document Repository. “Compliance Vault” is a product which supports document archiving, search, and retrieval, available through iConcepts, Inc. of Landsdale, Pa.

G. Business Rules & WorkFlow

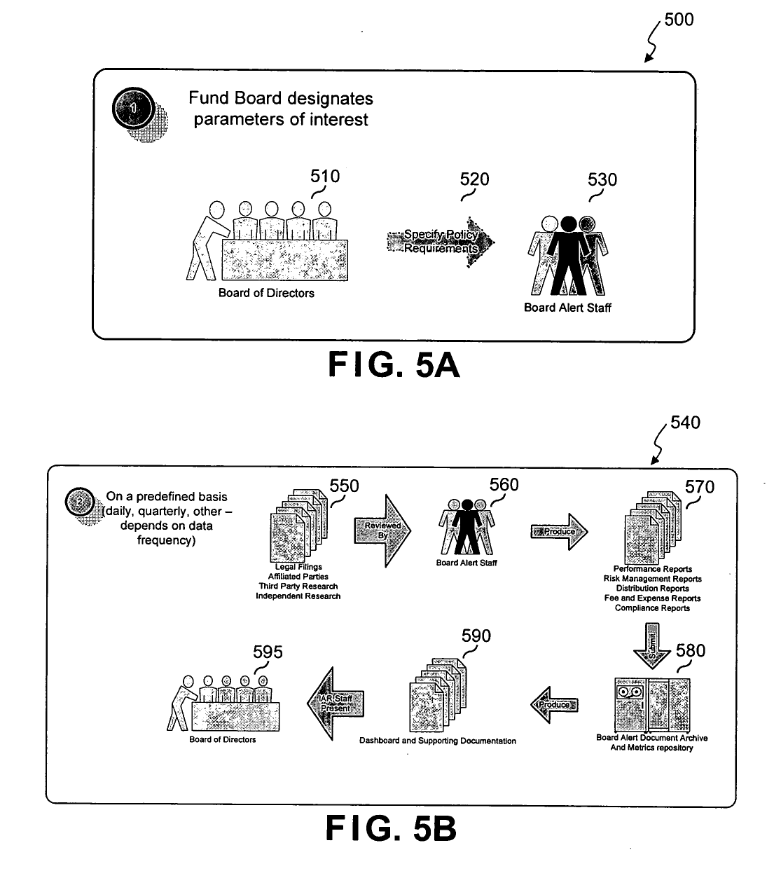

Turning now to FIGS. 5A and 5B, which comprise steps 500 and 540 respectively, there is shown, by way of non-limiting example, a method for development, maintenance, and implementation of the business rules and other Metrics to be employed in connection with the System of this invention. The business rules or other Metrics input into the System may include, but not limited to, the desired Metrics, Metric categories, calculation rules, business rules, and/or default and/or threshold values. The method of FIGS. 5A and 5B comprise the steps of the Fund Board establishing the Metrics of interest 500, and periodically reviewing such Metrics for optimization 540. In one embodiment of the invention, Step 540 may be based upon current data related to such Metrics.

In step 510, depicted in FIG. 5A, the Fund Board may designate the parameters, rules, and/or other Metrics which are tracked or otherwise utilized by the System. The Board may also specify certain policy requirements in step 520. In step 530, the Board may then communicate to the System staff (e.g., Board Alert staff) such parameters, policies and/or other Metrics which are to be considered. Optionally, the staff may also suggest, from, for example, a menu of parameters, the parameters to be tracked for each find. Non-limiting examples of parameter categories which may be included in such a parameter menu may include investment quality, risk management, distribution, expenses, tracking and compliance.

After the initial fund parameters, policies and other metrics are established in Step 500, such Metrics may be periodically reviewed in an effort to optimize the efficacy of the System in Step 540 depicted in FIG. 5B. Step 540, by way of non-limiting example, may comprise a method for such periodic review. In this embodiment, data, such as legal filings, independent and third party research, and other publicly and non-publicly available information may be collected in Step 550, and reviewed and analyzed by System staff in Step 560. In Step 570, the System staff then may produce reports based upon the information collected in Step 550, such as, for example, performance, risk management, distribution, fee and expense, compliance and other relevant reports. In Step 580, the staff then submits the reports produced in Step 570, as well as any other modifications to the Metrics, to the data storage Repository which comprises a document archive and metrics repository. In Step 590, the data storage Repository may then produce dashboard output information and supporting documentation based upon such information and reports submitted in Step 580, which may then be accessed by or presented to the Fund Board in Step 595.

H. Information Architecture

The information architecture of the System of this invention may comprise, but not be limited to, the following features:

1. Improved value and consistency of the information reaching the Fund Board, such as, for example, through the method depicted in FIGS. 5A and 5B;
2. Ensure that the information is provided to the Fund Board in a timely fashion through, for example the Dashboard Interface 244 or Broadcast E-mail 270 of FIG. 2;
3. Prioritize any policy changes or corrective actions for Fund Board consideration through, for example Dashboard Interface 244 of FIG. 2, and/or the method depicted in FIGS. 5A and 5B;
4. Centralize presentation of information and other data sources through, for example the Dashboard Interface 244 or Broadcast E-mail 270 of FIG. 2; and
5. Archive documents, reports and other information through, for example, Data Storage Repository 130 of FIG. 1 or Compliance Vault 230 of FIG. 2.
   I. User Experience

The System of the instant invention may be configured to create various User experiences depending on the objectives to be achieved and functionality desired by a particular Client. In one embodiment there may be three types of Users of the System: (1) End Users, such as for example, Fund Board Directors; (2) System Administrators or other authorized Users (such as, for example, staff internal to the entity hosting the System (such as BAS Administrator 250 of FIG. 2), or staff external to the entity hosting the System (such as persons associated with a fund company)); and (3) Power Users who have some, but not all, of the rights of a System Administrator. These Power or Super Users may be, for example, licensees of the System owner, or compliance officers at a client firm. Each group of Users may be granted different user experiences and authorizations within the System.

System Administrators or other authorized Users may be responsible for archiving the various analyses and/or benchmarking reports that may be created for a Fund. Such User's interaction with the System may, for example, be almost exclusively in Archive subsystem. These Users may also be responsible for the maintenance of the fund tracking parameter thresholds for the client funds. The functionality and sources of information (e.g., analysis and benchmarking reports, and parameter thresholds) required of the System Administrator will influence the form and functionality of the Dashboard Output Interface made available to the System Administrator.

Power/Super Users may be given many of the same rights and access as System Administrators. However, Power/Super Users may not be able to change data or Metrics, but may have the ability to control the data and/or Metrics the End User sees or otherwise may have access.

End Users (e.g., Fund Board Directors) may have access to the Dashboard Interface to help influence and make management decisions with respect to the Fund. End User's access rights within the System may be restricted to viewing outputs of the System (e.g., through the Dashboard Interface display), and accessing the underlying archived reports as may be useful in support of the End User's decision making.

Alternatively or additionally, End Users may have other rights within the System such as, for example, the ability to run “What if?” scenarios through the Dashboard Interface. In this regard, under the “What if?” scenario function, End Users may have the right to modify Metric, Dashboard, Threshold, or other defined parameters to see what output would result if such parameters were changed in the System.

J. Setting Fund Metrics

The System of the instant invention may be configured to permit the System Administrators or other authorized Users, and/or End Users, such as for example, Fund Board Directors to set a subset of the available Fund tracking parameters or other Metrics which are to be tracked by the System. The System Administrator may then go through a setup process in the Dashboard Generation Engine of the System, such as, for example, Dashboard Generator 242 of FIG. 2. This process may involve adding information about the Fund (e.g., name, type of fund, reporting schedule, etc.), selecting a set of parameters that may be associated with the Fund, and setting the Threshold and other Metric and parameter values.

Metrics, which may be used in connection with the System, may include, but may not be limited to, the following:

| Metrics | Description |
|---|---|
| Performance Consistency (Batting Average) | Measures the frequency with which the |
| | advisor beats the benchmark or peer group |
| | over fixed periods (fee adjusted). |
| Performance Persistency | Measures how often the manager beats the |
| | benchmark or peer group over rolling periods |
| | (fee adjusted). |
| Management Team Tenure | Measures how long the manager and key |
| | analysts have successfully managed this fund. |
| Risk Adjusted Return | Measures the ability of the manager to |
| | produce return that exceeds the amount of |
| | risk takes (fee adjusted). |
| Up/Down Capture | Measures the managers ability to outperform |
| | in up and down markets. |
| Process Adherence | Measure whether the manager is executing |
| | the stated investment process. |
| Portfolio Volatility | Measures the variation of returns from the |
| | average return versus the benchmark or peer |
| | group. |
| Sector Bets | Measures the extent to which the portfolio |
| | has taken individual sector bets versus the |
| | benchmark. |
| Security Bets | Measures the extent to which the portfolio |
| | has taken individual security bets versus the |
| | benchmark. |
| Tracking Error | Measures the expected deviation in returns |
| | versus the benchmark in percentage return. |
| Liquidity | Measures the ability of the fund to meet short |
| | term cash needs. |
| Total Fund Expenses | Measures total fund expenses versus the |
| | Morningstar category size adjusted peer |
| | group average. |
| Advisor/Management Fees | Measures advisory fee versus the Morningstar |
| | category size adjusted peer group average |
| Total Expenses Less Advisory Fees | Measures the non-advisory fee expenses |
| | versus the Morningstar category peer group. |
| Administration Expenses | Measures fund's administration expenses |
| | versus the Morningstar category size adjusted |
| | peer group average. |
| Average Account Size | Measures average account size versus the |
| | average for the Morningstar category and |
| | fund age peer group. |
| Below minimum Balance Accounts | Measures the number of accounts below |
| | “breakeven”. |
| Board Expenses | Measures the fund board expenses versus the |
| | Morningstar category peer group. |
| Portfolio Holding Characteristics | Measures Sector, Industry, Credit Quality, |
| | security limits. |
| NAV Accuracy | Measures the frequency of NAV calculation |
| | errors or late pricing of funds. |
| Portfolio Manager Ownership | Measures significant changes in ownership in |
| | the fund by portfolio manager(s). |
| Matching Trades | Measures the number of large matching |
| | trades in and out within 30 days. |
| Velocity In/Out | Measures the ratio of purchases and |
| | redemptions (churn) over the past 30 days. |
| Portfolio manager Trading | Measures the frequency of portfolio managers |
| | trading in securities available for purchase by |
| | the fund. |
| Regulatory Complaints | Measures the number of regulatory |
| | complaints filed against the officer of the |
| | fund company and investment advisor. |
| Net New Assets/12b-1 Expense | Measures net new assets raised per 12b-1 |
| | expenses as a measure of distribution |
| | efficiency. |
| New Revenue Sharing Agreement | Identifies the addition of any new revenue |
| | sharing agreements. |
| Net New Assets vs. Peer Group | Measures the non-advisory fee expenses |
| | versus the Morningstar category peer group. |
| # New Small Balance Accounts | Measures fund's administration expenses |
| | versus the Morningstar category size adjusted |
| | peer group average. |
| Average Account Size New Accounts | Measures average account size versus the |
| | average for the Morningstar category and |
| | fund age peer group. |
| Discretionary Assets | Measures the number of accounts below |
| | “breakeven”. |

K. Metric Archive

Metrics and other parameters established on the System may be archived in a historical data repository maintained on the Data Storage Repository, such as, for example, Data Storage Repository 130 of FIG. 1 or Compliance Vault 230 of FIG. 2

L. Archiving Analysis Reports and Other Data

At designated points throughout the normal workflow of the business and use of the System, System Administrators or other authorized Users, and/or End Users, such as for example, Fund Board Directors, may add report products and other relevant supporting data to the System historical data archive maintained in, for example, Data Storage Repository 130 of FIG. 1 or Compliance Vault 230 of FIG. 2. The data may be accessible to generate the Dashboard Interface display (such as BAS Dashboard Interface 244 of FIG. 2) through for example Dashboard Generator 242 of FIG. 2. The data may also be archived by Authorized Users through an Authorized User System interface.

M. Creating Dashboard for End User

A dashboard may be created for a fund. This may be dependent on the fund being set up in the System database, and presence of required analysis reports in the System archive.

N. Creating Dashboard Detail Reports

In addition to the Dashboard Interface visual display indicators (which may include for example, Color Metric Status Indicators 424, 434, 454, and 464, and Relative Status Indicators 436, 444, and 464 of FIG. 4), the System may generate reports that provide detail on the Metrics or other parameters tracked through the Dashboard Monitoring System, such as for example Dashboard Monitoring Systems 140 and 240 of FIGS. 1 and 2, respectively. This feature may enable an analyst or other Authorized User to search the System archive and extract information relevant to a particular Fund and Metrics or other measurement parameters.

O. System Content

Content, such as, for example, data, documents, information, Metrics, historical and other archived information, maintained on the System may be classified on the System by User type. For example, Administrative Users may be presented with the choices of Metrics or other parameters that are available within the System. Administrative Users may also have authorization to select and set values or other Metrics for each Fund/Metric combination, and determine the Content available on the System which will be made available to a particular User type based upon certain Metric and other settings.

The Content available to the End User also may be based upon the information that has been archived on the System. The presentation of the Content may be provided to an End User, for example, in two forms: the Dashboard Interface display, and/or by viewing the output of a Data Storage Repository archive search and retrieval.

P. Site Structure

The System of this invention may be worldwide web, Internet, or extranet based, with interfacing occurring through browser (such as, for example, NetScape or Internet Explorer) windows. Since portions of the System may be built using “Compliance Vault” technology, available through iConcepts, Inc. of Landsdale, Pa., the System structure may be, at least in part, similar to or influenced by the structure and/or architecture of that of iConcepts “Compliance Vault” technology. Other portions of the System (e.g., dashboard display and administration functionality) may be designed to meet most any System requirements.

Q. Data Management

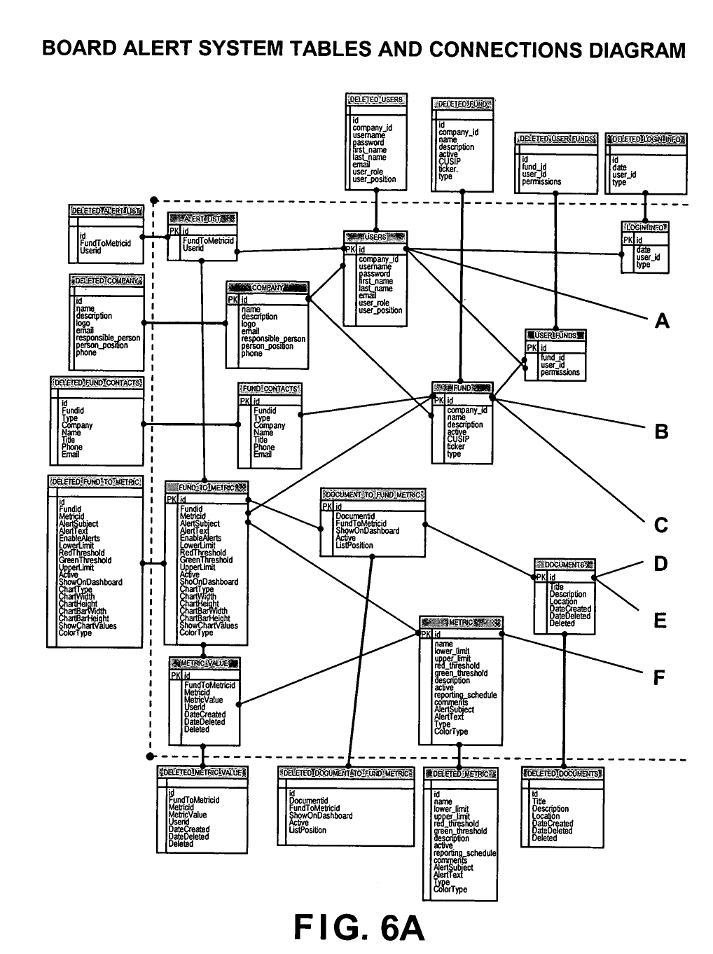

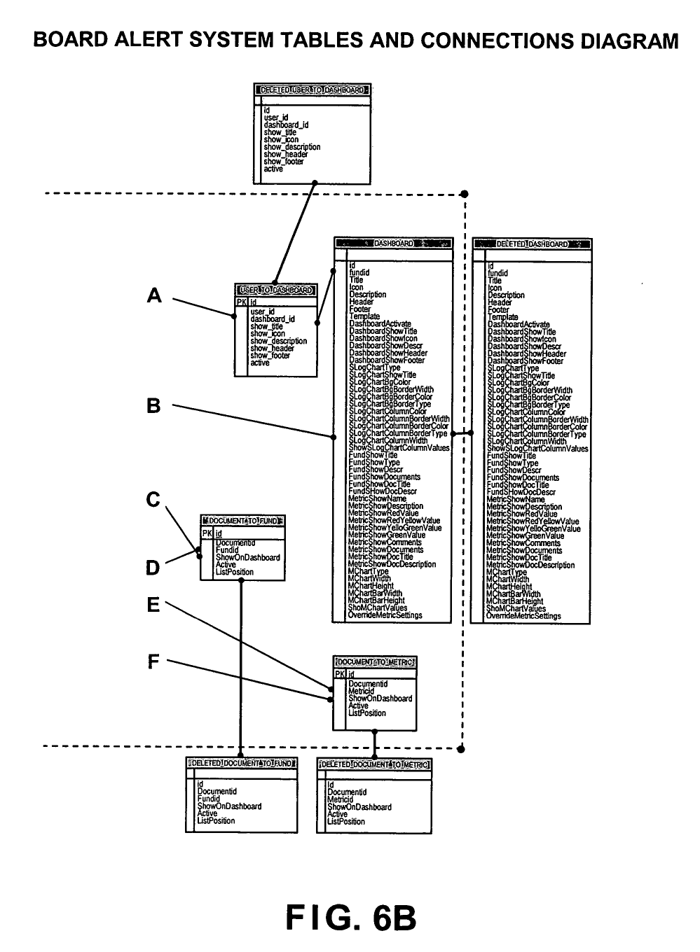

Generally, but without limitation, at least two types of data may be stored or otherwise managed by the System: (1) raw data received through the Data Collection Engine, and data analysis reports entered by Administrative staff or other Users and other Content; and (2) data required to support the System operation (e.g., User information, parameter and other Metric values, Fund information, etc.) Report data may be stored using “Compliance Vault” technology or other Data Storage Repository. The remaining Metrics data may be stored in and accessed through relational database tables, such as, by way of non-limiting example the relational database table set forth in FIGS. 6A and 6B.

R. External Interfaces

Interfaces external to the System may be in the form of data feeds purchased or otherwise accessed through third party sources, such as, for example, the vendors which provide Vendor Data Reports 214 through Data Collection Engine 210.

S. Non-Functional Requirements

1. Usability

End Users may include, for example, Fund Board members and other advisors to the Fund. The System may be configured to accommodate End Users regardless of the User's level of computer or Internet sophistication.

2. Client Environment

The System of the present invention may be configured to support ancillary applications such as web browsers and plug-ins to enhance the User experience and functionality of the System. Such applications may include, but are not limited to, Acrobat Reader Plug-in, Netscape Navigator, Microsoft Internet Explorer, Mozilla, and Mozilla Firefox.

3. Security

The System may comprise one or more of the following security features:
1. Use of a username and password for access control.
2. Role-based security access to the functions provided in the System.
3. Prohibit select Users from viewing or changing certain data and/or Metrics maintained on the System such as, for example, limit a User's access to the account or Fund only to the account or Fund to which the User has authorized access.
4. 128-bit Secure Socket Layer protocol for HTTP traffic encryption.
5. Changes to fund parameters or other Metrics may be tracked by date, user and action taken, to support audit or other requirements.
6. All elements of Metric calculations may be stored on the System such that, if required, calculations may be verified.
   T. User Interaction With System

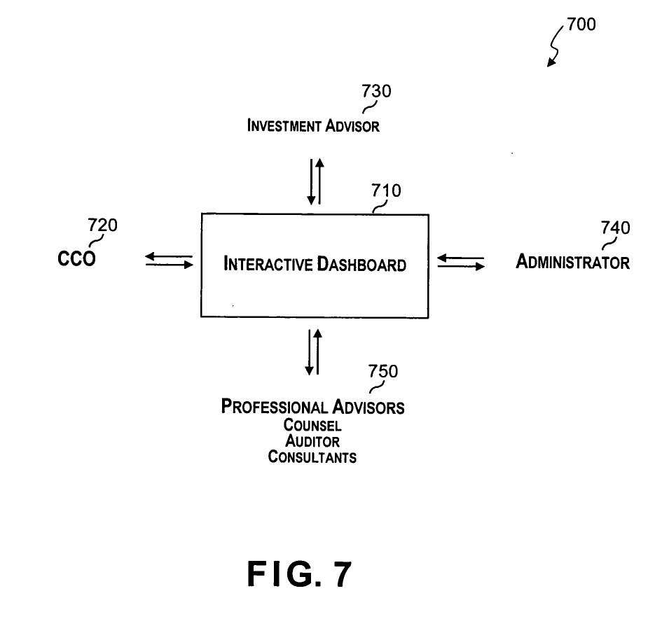

Turning now to FIG. 7, there is shown a graphical representation of yet another embodiment of the System of the instant invention, designated as 700, and Users, designated as 720, 730, 740 and 750, who interact with System 700. Interactive Dashboard 710, which is integral to System 700, and which may comprise, for example, Dashboard Monitoring System 140 of FIG. 1, or Dashboard Monitoring System 240 of FIG. 2, may be simultaneously accessed by Users 720, 730, 740 and 750 of System 700 through Interactive Dashboard 710. In addition, Users 720, 730, 740 and 750 may be provided with simultaneous access to the data and other information contained in System 700, including, for example, data and other information appearing through Interactive Dashboard 710 as, for example, Screen 400 of FIG. 4. Such simultaneous access provides a reliable source of information presented in a consistent manner to Users 720, 730, 740 and 750 of System 700. Given such reliability and consistency in resources, System 700 may, therefore, influence and drive User's 720, 730, 740 and 750 behavior resulting in enhanced consistency in the data and other information relied upon for their for decision making.

Additional Embodiment of System

The following is a non-limiting example of how an embodiment of the System of this invention may operate for an investment find named the “XYZ Growth Fund”:

A. System Set-Up:

1. XYZ Fund Board of Directors identify an Essential Measure or Metric: Relative Performance Consistency (“RPC”).
2. BAS, the System Administrator, assists Board in defining the RPC formula:
   a. RPC=1 year category ranking * 50%+3 year category ranking * 30%+5 year category ranking * 20%.
3. Directors and BAS or other administering body (referred to herein as “BAS”), select the category comparison based on fund objectives, size, share class, distribution methods, etc.
4. BAS or System chooses a fuel gauge Relative Status Indicator as best method of displaying results through a Dashboard Interface.
5. Directors define the Threshold values for the RPC which define the Board's expectations and match such expectations to corresponding Relative Status Indicator settings as follows:
   a. Green Indicator Threshold Level—RPC better than 50^{th} percentile.
   b. Yellow Indicator Threshold Level—RPC between 51^{st} and 60^{th} percentile.
   c. Red Indicator Threshold Level—RPC below 60^{th} percentile.
6. Chief Compliance Officer (“CCO”) defines the alert message to send through the Broadcast E-Mail Module (such as, for example, Broadcast E-Mail Module 270 of FIG. 2) if indicator turns red. For example, upon receiving a red indicator through the System, the Fund's investment advisor is required to submit to the Board a written detailed description and analysis of the Fund's performance.

7. The CCO defines which System Users will receive the e-mail message or alert generated by the Broadcast E-Mail Module as a result of a red indicator.

B. Dashboard Operation

1. System runs such as, for example, through Data Collection Engine 210, a series of automated reports delivered by software vendor FACTSET which is, for example, one of the selected Vendor Data Reports 214.
2. System retrieves 1 year, 3year, and 5 year category rankings for XYZ Fund, and transfers the each of the three year category ranking values into the RPC algorithm software, wherein such algorithm is, for example, maintained on BAS Analysis Module 220.
3. BAS Analysis Module 220 software calculates the RPC value, which results in the calculated RPC value falling in 75^{th} percentile.
4. The calculated RPC value is automatically sent to a Threshold table contained in, for example, Threshold Module 246.
5. The Dashboard automatically looks (for example, through Dashboard Generator 242) at the Threshold table, and compares the calculated RPC value to the Threshold value each day (or at some other predetermined period). Alternatively, Threshold Module 246 periodically and automatically may send the RPC Threshold value to Dashboard Generator 242 for comparison to the calculated RPC value maintained in Dashboard Generator 242.
6. A report related to the RPC calculation and comparison is generated by Dashboard Generator 242, complete with charts and supporting documentation linked or otherwise attached to the report. The report is then archived in Compliance Vault 230.
7. Because the RPC of 75% falls in the Red Indicator Threshold Level, an E-Mail Alert is sent out to all Board Directors, the CCO, and the Fund investment advisor by Broadcast E-Mail Module 270.
8. The RPC Report stored in Compliance Vault 230 may be attached to the E-Mail Alert sent to all Board Directors, the CCO, and the Fund investment advisor.
9. Upon receipt of the E-Mail Alert notification, the Board Directors and other E-Mail Alert Recipients may go to Dashboard Interface website 244 to check on the E-Mail Alert. Recipients notice that the RPC performance consistency gauge on Dashboard Interface 244 is bolded as it has changed since the Recipient's last login. Recipients may click on the document icon next to the RPC gauge (similar to, for example, the File or Document Attachment Link Icons shown in FIG. 4), and retrieve the full report on RPC performance maintained in Compliance Vault 230. The Recipients then see that the RPC Metric has been declining over the past six months.
10. In accordance with established Fund procedures, the Fund investment advisor sends to the CCO an Advisory E-Mail containing an explanation of the current status of the Fund, together with options for correction and relevant documentation, within three (3) days of receipt of the E-Mail Alert.
11. Also, in accordance with established Fund procedures, the RPC documentation is E-Mailed to the Fund Board Directors and added to Compliance Vault 230.
12. The Board Directors may also use Broadcast E-Mail Module 270 to share and discuss the RPC documentation as well as the performance of the Fund.
13. In accordance with established Fund procedure, an Independent Fund Chairman submits to the CCO an E-Mail Response to the Fund investment advisor's Advisory E-Mail explaining the need for a formal presentation at the next meeting of the Board. The CCO then attaches the Chairman's E-Mail Response to the RPC Metric maintained in Compliance Vault 230.
14. The CCO then resets, through the System, the RPC Metric to yellow, with a special temporary reset Threshold value pending the next meeting of the Fund Board. The CCO also adds the RPC issue to the agenda for the next meeting of the Fund Board.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

What is claimed is:

1. An method for automatically reporting output information to a user, said method comprising the steps of:
establishing one or more types of said output information to be reported to said user;
collecting data in a database;
establishing one or more rules to be applied to said data;
applying said one or more rules to said data to produce said output information;
establishing one or more thresholds corresponding to said output information;
comparing said output information to said thresholds; and
reporting said output information corresponding to said information type to be reported to said user through an output interface.

2. The method of claim 1, wherein said output interface may be customized by said user to report output information desired by said user.

3. The method of claim 1, wherein said output interface enables said user to specify said rules.

4. The method of claim 1, wherein said output interface enables said thresholds to be specified.

5. The method of claim 1, wherein said output interface comprises a graphical dashboard.

6. The method of claim 1, wherein said data in said database is collected from at least publicly available sources.

7. The method of claim 1, wherein said data in said database is collected from at least said output information.

8. The method of claim 1, wherein said rules comprise algorithms, parameters, metrics or protocols.

9. The method of claim 1, wherein said output interface enables thresholds, and rules to be adjusted to generate alternative output information.

10. The method of claim 1, wherein said output information may be transmitted to select users based upon said output information.

11. An automated system for reporting output information to a user comprising:
a database repository, said database repository for collecting data;
a database analysis engine, said analysis engine comprising a processor which processes said data to produce said output information;
an output information generator, said generator comprising a threshold comparator which compares thresholds corresponding to said output information; and
an output interface, said output interface comprising a reporting function which reports said output information to said user.

12. The system of claim 11, wherein said output interface may be customized by said user to report output information desired by said user.

13. The system of claim 11, wherein said output interface enables said user to specify said rules.

14. The system of claim 11, wherein said output interface enables said thresholds to be specified.

15. The system of claim 11, wherein said output interface comprises a graphical dashboard.

16. The system of claim 11, wherein said data in said database is collected from at least publicly available sources.

17. The system of claim 11, wherein said data in said database is collected from at least said output information.

18. The system of claim 11, wherein said rules comprise algorithms, parameters, metrics or protocols.

19. The system of claim 11, wherein said output interface enables thresholds, and rules to be adjusted to generate alternative output information.

20. The system of claim 11, wherein said output information may be transmitted to select users based upon said output information.

21. A system for monitoring specified metrics, said system comprising:
a data collection engine which collects data related to said metrics;
a data analysis engine which analyzes said data collected by said data collection engine to produce analyzed data related to said metrics;
a data storage repository which provides a repository for said data collected by said data collection engine, and said analyzed data produced by said data analysis engine; and
a dashboard monitoring system which provides an output mechanism for reporting data collected by said data collection engine, and said analyzed data produced by said data analysis engine.

22. The system of claim 21, wherein said metrics being monitored are related to one or more financial investment funds or other investment vehicle.

23. The system of claim 21, wherein said output mechanism comprises an interactive graphical user interface which displays specified collected and/or analyzed data corresponding to said metrics.

24. The system of claim 21, wherein authorized users of the system may alter parameters related to said metrics to generate theoretical output data.

25. The system of claim 22 further comprising an automated alert system which alerts select system users when specified investment vehicle metrics fall outside of established investment vehicle parameters.

26. The system of claim 21, wherein said dashboard monitoring system further comprises a data input mechanism.

27. The system of claim 26, wherein said data input mechanism comprises a direct data input function.

28. A method for monitoring specified metrics, said method comprising the steps of:
collecting data related to said metrics through a data collection engine;
analyzing through a data analysis engine said data collected by said data collection engine to produce analyzed data related to said metrics;
providing a data storage repository which repository stores said data collected by said data collection engine, and said analyzed data produced by said data analysis engine; and
providing a dashboard monitoring system having an output mechanism for reporting data collected by said data collection engine, and said analyzed data produced by said data analysis engine.

29. The method of claim 28, wherein said metrics being monitored are related to one or more financial investment funds or other investment vehicle.

30. The method of claim 28, wherein said output mechanism comprises an interactive graphical user interface which displays specified collected and/or analyzed data corresponding to said metrics.

31. The method of claim 28, further comprising the step of altering said parameters related to said metrics to generate theoretical output data.

32. The method of claim 29, further comprising the step of automatically generating an alert or other notification when specified investment vehicle metrics fall outside of established investment vehicle parameters.

33. The method of claim 28, further comprising the step of providing a data input mechanism through said dashboard monitoring system.

34. The method of claim 33, wherein said data input mechanism comprises a direct data input function.
